(19) United States
(12) Patent Application Publication
(10) Pub. No.: US 2006/0237665 A1
(43) Pub. Date: Oct. 26, 2006

(54) Bioaerosol discrimination

(76) Inventors: William S. Barney, Bedford, MA (US); Thomas E. Doerfler, Clinton, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/343,970

(22) Filed: Jan. 30, 2006

Related U.S. Application Data
(63) Continuation-in-part of application No. 10/797,716, filed on Mar. 10, 2004, now Pat. No. 7,060,992.
(60) Provisional application No. 60/453,325, filed on Mar. 10, 2003.

(51) Int. Cl. G01N 21/64

(52) U.S. Cl. 250/458.1

(57) ABSTRACT

The systems and methods of the invention utilize time-resolved techniques to deconvolve a measured response to characterize the nature of particles. The measured response is deconvolved into a scatter component and a fluorescence component. The fluorescence component is further characterized into biological and non-biological components. Probability techniques are utilized to predict whether the particles are biological or non-biological.

### CROSS-REFERENCE TO RELATED APPLICATIONS

This application is a continuation-in-part of and claims the benefit under 35 U.S.C. §120 to pending U.S. patent application Ser. No. 10/797,716, entitled “System and Method for Bioaerosol Discrimination by Time-Resolved Fluorescence,” filed on Mar. 10, 2004, which claims priority under 35 U.S.C. §119(e) to U.S. Provisional Application Ser. No. 60/453,325, entitled “Method for Bioaerosol Discrimination by Time-Resolved Laser Induced Fluorescence (TRILIF),” filed on Mar. 10, 2003, each of which is herein incorporated by reference in its entirety.

### BACKGROUND OF THE INVENTION

1. Field of the Invention

The invention relates to classifying particles and, in particular, to utilizing time-based fluorescence techniques to characterize the biological nature of aerosol particles.

2. Discussion of Related Art

Detection of biological aerosol particles or bioaerosois can be important in many fields including, for example, agriculture, food processing, public health, worker safety, resident/patient safety, disease prevention and eradication, emergency response, homeland defense and counterterrorism, and military base and force protection because bioaerosols may be harmful to human or animal health. Intrinsic particle fluorescence is a method that be utilized to distinguish biological particles from non-biological background particles. However, atmospheric pollutants may also fluoresce and can cause fluorescence-based instruments to register false positive indications.

Various systems and methods can be utilized to characterize the nature of aerosol particles. For example, common detectors, cue detectors or trigger detectors, are typically optical scattering particle counters equipped with laser-induced fluorescence detection devices. Typically in such a system, an ultraviolet laser beam excites a particle to be examined. The particle's resultant fluorescence can be dispersed into two detection channels, roughly divided between ultraviolet and visible wavelengths. The particle is thereafter classified as threatening or non-threatening according to its relative position on a three-dimensional graph of UV intensity, visible intensity, and scattering intensity. While progress has been made these detectors still suffer from potential interference due to background fluorescence.

For example, Brewer, in U.S. Pat. No. 3,566,114, discloses a method and means for detection of microorganisms in the atmosphere. Macias et al., in U.S. Pat. No. 4,013,888, disclose a monitor for atmospheric pollutants. Javan, in U.S. Pat. No. 4,561,010, discloses a method and apparatus for fluorescent sensing. Hirako et al., in U.S. Pat. No. 5,158,889, disclose a biological cell sorter. Ho, in U.S. Pat. Nos. 5,701,012 and 5,895,922, discloses fluorescent biological particle detection systems. Gillispie et al., in U.S. Pat. No. 5,828,452, disclose a spectroscopic system with a single converter and method for removing overlay in time of detected emissions. Zborowski et al., in U.S. Pat. No. 6,142,025, disclose a method for determining particle characteristics. Fukuda et al., in U.S. Pat. No. 6,165,740, disclose a method and device for flow-cytometric microorganism analysis. Jeys et al., in U.S. Pat. No. 6,194,731, disclose a bio-particle fluorescence detector. Ray et al., in U.S. Pat. No. 6,608,677, disclose a mini-LIDAR sensor for the remote stand-off sensing of chemical/biological substances and methods for sensing same. Simonson et al., in U.S. Pat. No. 6,617,591, disclose a method for remote detection of trace contaminants. Carrión et al., in U.S. Pat. No. 6,630,299, disclose fluorescence detection. Gillispie, in U.S. Patent Application Publication 2002/0158211, disclose a multi-dimensional fluorescence apparatus and method for rapid and highly sensitive quantitative analysis of mixtures.

### BRIEF SUMMARY OF INVENTION

In accordance with one or more embodiments, the present invention relates to a system for classifying aerosol particles. The system can comprise a detector capable of generating a signal corresponding to a composite emission decay profile of an emission from an aerosol particle and a means for deconvolving the signal into a discriminant vector that provides an indication of the nature of the aerosol particle.

In accordance with one or more embodiments, the present invention relates to a system for classifying aerosol particles. The system can comprise a detector capable of generating a signal corresponding to a composite emission decay profile of an emission from a sample of aerosol particles and a processor coupled to the detector to receive the signal. The processor can determine a scatter component and a fluorescence component of the composite emission decay profile.

In accordance with one or more embodiments, the present invention relates to a method of classifying an aerosol particle. The method can comprise measuring a composite emission decay profile of an emission from the aerosol particle, determining a biological fluorescence time constant of the composite emission decay profile, and determining a biological emission constant of the composite emission decay profile.

In accordance with one or more embodiments, the present invention relates to a method of classifying aerosol particles. The method can comprise stimulating the aerosol particles to promote radiation emission; measuring a composite emission decay profile of the radiation emission, the composite emission decay profile comprising a scatter component, a first fluorescence component, and a second fluorescence component; determining a scatter emission constant corresponding to the scatter component; determining a first fluorescence emission constant of the composite emission decay profile; and determining a second fluorescence emission constant of the composite emission decay profile.

In accordance with one or more embodiments, the present invention relates to a method of classifying an aerosol particle. The method can comprise measuring a composite emission from an aerosol particle, deconvolving the composite emission to determine a discriminant vector of the aerosol particle, and mapping the discriminant vector to provide an indication of the nature of the aerosol particle.

In accordance with one or more embodiments, the present invention relates to a method of characterizing an aerosol particle. The method can comprise acts of measuring a first composite emission decay profile of a first emission from the aerosol particle, measuring a second composite emission decay profile of a second emission from the aerosol particle, determining a biological fluorescence time constant of the first composite emission decay profile, determining a biological fluorescence time constant of the second composite emission decay profile, determining a first biological emission constant of the first composite emission decay profile, and determining a second biological emission constant of the second composite emission decay profile.

In accordance with one or more embodiments, the present invention relates to a system for classifying aerosol particles. The system can comprise a first detector capable of generating a first signal corresponding to a composite emission decay profile of a first emission from an aerosol particle, a second detector capable of generating a second signal corresponding to a composite emission decay profile of a second emission from the aerosol particle, and a means for deconvolving the first and second signals into at least one discriminant vector that provides an indication of the nature of the aerosol particle.

In accordance with one or more embodiments, the present invention relates to a system for classifying aerosol particles. The system can comprise a first detector capable of generating a first signal corresponding to a first composite emission decay profile of a first emission from an aerosol particle, a second detector capable of generating a second signal corresponding to a second composite emission decay profile of a second emission from the aerosol particle, and a processor coupled to the first and second detectors to receive the first and second signals. The processor can determine a first scatter component and a first fluorescence component of the first composite emission decay profile and determine a second scatter component and a second fluorescence component of the second composite emission decay profile.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a graph showing a response, exemplarily shown as a composite emission decay profile, from an aerosol particle in accordance with one or more embodiments of the present invention;

FIG. 2 is a schematic diagram showing a system in accordance with one or more embodiments of the present invention;

FIG. 3 is a schematic diagram of a flow cell utilizable in accordance with one or more embodiments of the present invention;

FIG. 4 is a graph showing components of the decay shown in FIG. 1;

FIG. 5 is map characterizing deconvolved results in accordance with one or more embodiments of the present invention;

FIG. 6 is a graph showing the relative nature of a scatter component (A), a biological fluorescence component (B), and a non-biological fluorescence component (C) of a typical decay response;

FIGS. 7A-7E are graphs showing constructed, prophetic decay responses for various particles as discussed in the examples;

FIG. 8 is a map characterizing the nature of the various particles having responses shown in FIGS. 7A-7E and as discussed in the examples;

FIG. 9 is a schematic diagram showing a system utilizing a plurality of wavelengths in accordance with one or more embodiments of the invention;

FIG. 10 includes graphs showing the expected concentrations of the PAHs pyrene, fluorene, phenanthrene, anthracene, and naphthalene associated with atmospheric particles in a polluted atmosphere, used to calculate the decay curves shown in FIG. 11;

FIG. 11 are graphs showing (a) the expected decay curves of a PAH-coated bacterial cluster and a PAH-coated polystyrene latex (PSL) sphere and (b) the normalized decay curves, relative to unit intensity, of the PAH-coated bacterial cluster and the PAH-coated polystyrene latex sphere;

FIG. 12 are graphs showing time bins utilized to integrate decay curves (upper graph) and a histograms of the number of photons in each bin for bacterial and PSL decays of FIG. 11 as discussed in Example 5; and

FIG. 13 is a graph showing a phase space characterizing particle types and classification regions in accordance with one or more embodiments of the invention.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Detectable fluorescent compounds include, for example, polycyclic aromatic hydrocarbons (PAHs). Typical sources of PAH species are combustion sources, including for example, internal combustion engines that utilize gasoline or diesel fuel. Such sources typically discharge PAH species on soot particles, which though small, can aggregate and grow to larger size. Some PAH species are semivolatile, and will partially evaporate into the gas phase and may re-condense on other particles. Thus, in some cases, non-fluorescent particles may become fluorescent, especially where significant concentrations of PAH species would be present. In some cases, fluorescence due to PAH condensation on non-fluorescent particles may equal or exceed that from similarly-sized biological aerosol particles. Such PAH-contaminated particles can create false conditions. For example, the detecting instrument may register a false positive when non-biological species are present; or high levels of fluorescence from non-biological species may mask fluorescence from biological species, causing a false negative. Biological molecules have typically short fluorescence lifetimes, about less than 1 to about 7 ns. In contrast, atmospheric PAH species have typically much longer lifetimes, typically exceeding 7 ns, and in some cases, from 10 ns to hundreds of nanoseconds.

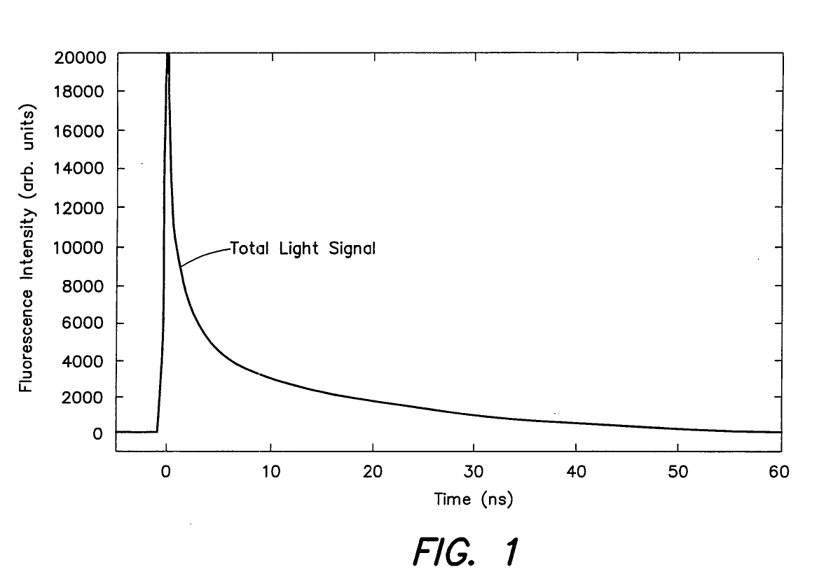

Biological aerosol particles can be excited to produce fluorescence from biological fluorophores such as tryptophan, tyrosine, NADH, and/or flavin compounds, which would typically be present in such bioaerosol particles. In some cases, such particles can also scatter radiation as a scattered light pulse. Said excitation event can produce a signal pulse, typically a composite emission decay profile or composite intensity, exemplarily shown in FIG. 1. The composite emission decay profile typically includes a scatter component and a fluorescence component typically from one or more of particle-bound biological fluorophores; particle-bound, non-biological organic fluorophores; and, in some cases, gas phase, non-biological organic fluorophores present.

The systems and techniques of the invention can be characterized as discriminating between biological fluorescence and background pollution fluorescence, such as non-biological fluorescence.

In accordance with one or more embodiments, the invention provides a method and system that employs a time emission decay profile, or fluorescence lifetime, to discriminate or characterize a sample of aerosol particles, in some cases or preferably, without the need for fluorescence wavelength information.

In accordance with some aspects, the systems and techniques of the invention can be characterized as providing a time-resolved, spectrally integrated, induced fluorescence technique. For example and in accordance with one or more embodiments of such aspects, the invention can provide a system and a method for using time-resolved light detection to discriminate between classes or types of fluorescing molecules to detect and, in some cases, count biological aerosol particles. The methods and systems of the invention can classify sources of light according to, for example, arrival time at one or more detectors. For example, very fast-arriving light, typically arriving less than about 0.1 nanoseconds (ns) relative to, typically the center, of an initiating emission, such as but not limited to a laser-produced light pulse, can be classified as scattered light; fast-arriving light, typically arriving less than about 1 ns to about 7 ns, can be classified as having a biological fluorescence origin; and slow-arriving light, typically arriving greater than 7 ns, can be classified as fluorescence of a non-biological nature or origin. In some cases, because the processes can begin simultaneously, some of the emitted light can be distinguished as fast fluorescence in nature and some of the fast fluorescence can be measured slow fluorescence. Accordingly, the systems and techniques of the present invention can correct for any overlap between such categories.

The invention can be directed to tiered biological aerosol particle detection systems. For example, a first tier can comprise a fast, sensitive cue detector that typically operates, preferably continuously, to detect suspicious events. When such an event is detected, the fast detector, also referred to as trigger detectors, typically cues a highly specific identification detector or detector array that particularly classifies the nature of the suspicious event, e.g., whether a bioaerosol should be considered as non-threatening or threatening, such as anthrax. Such a configuration can reduce false alarms without the expense and maintenance burden typically associated with continuously operating the specific identification detector by providing a characterization of the nature of emitted light from candidate particles. Thus, in accordance with one or more embodiments, the invention can, for example, utilize time resolved induced fluorescence techniques to detect suspicious events and cue or trigger one or more specific identification detectors.

In accordance with one or more embodiments, the systems and techniques of the invention can detect natural, induced, and/or resultant emissions, such as reflections or fluorescence of a sample comprising bioaerosol particles and resolve or deconvolve a response such as a composite time-dependent intensity into any one of a scatter component, non-biological component, and biological component. The measured intensity can be resolved into one or more non-biological components and, in some cases, one or more biological components.

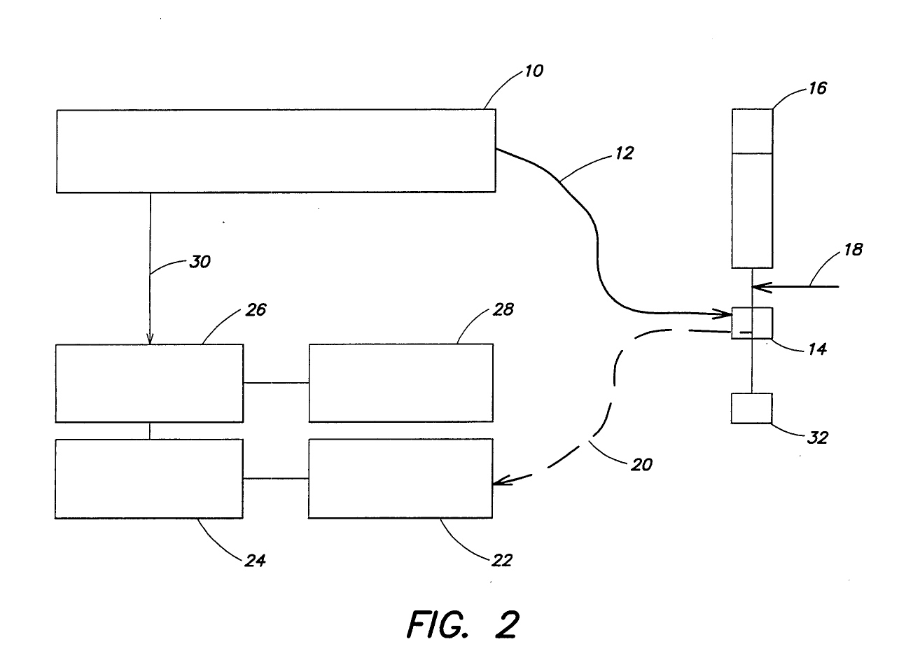

The measurable emission can result naturally or be induced by an energy source. For example, aerosol particles can be excited to emit fluorescence by one or more electromagnetic radiation systems. The energy source can emit excitation energy in one or a spectrum of wavelengths. In accordance with one or more embodiments, the energy source 10 of the system of the invention can comprise one or more electromagnetic radiation sources such as, but not limited to one or more lasers, as exemplarily shown in FIG. 2. Preferably, the excitation device, such as laser 10, can emit radiation, shown being transmitted through one or more optical fibers 12, with a pulse width sufficiently small that the scattering signal decay can be distinguished from a typical decay profile, e.g., a 1 ns emission decay profile. For example, a suitable pulse width can be less than about 5 ns and is preferably less than about 500 ps. The responses, such as a composite emission decay profile, typically scattered and/or emitted energy from the particles can be directed through one or more optical fibers 20 to devices that can amplify and/or convert the response to one or more analyzable signals. For example, the response can be directed to a monochromator 22, a photomultiplier 24, and/or and oscilloscope 26.

The signal can then be analyzed by, for example, deconvolution, to identify components thereof in, for example computer 28. Computer 28 can further analyze the deconvolved signal into a discriminant vector, which can be mapped to provide a characterization of the biological/non-biological nature of the particles. The system can further comprise filter 32 to reduce any scatter component. As used herein, the term “discriminant vector” refers to the deconvolved or derived components of a response from a particle. Typically each response for a particle has an associated discriminant vector which can be compared by, for example, mapping to provide a characterization of the nature of the particle. For example, the discriminant vector can be mapped to provide an indication of a biological and/or non-biological aspect of the particle.

Optionally, a trigger signal 30 can be directed to, for example oscilloscope 26, to provide an index for initiation of analysis sequences.

The excitation radiation energy or light may interact with particles in a defined region of space and observed and/or a parameter thereof measured by a detector. The interaction region can be enclosed in a flow cell 14, which can prevent unwanted ambient particles and unwanted ambient light from contamination or otherwise introducing unquantifiable interferences. Particles to be analyzed, from source 16, can be introduced into flow cell 14 through a small nozzle, to confine them to a well-defined interaction region where the excitation energy, such as a laser light, can be concentrated, and where the detection optics or optical devices can focus, for efficient collection of emissions. Preferably, the particle stream is accompanied, more preferably, surrounded, with an annular flow of particle-free air, which is typically referred to as sheath air 18. Sheath air 18 can further collimate the particle stream so that it can be confined in the interaction region and can prevent particle deposition on the optic components of the system. More preferably, annular flows of the particle stream and the sheath air are combined or flow isokinetically, with the same velocity, to reduce any turbulent mixing that may cause particles to be transported from the inner flow region to the outer flow region. Concave mirrors, spherical, parabolic, or elliptical, can be further utilized to direct or reflect emitted energy, e.g., light, traveling away from the collection optic components, so that it can travel toward and be captured by the collection optic components.

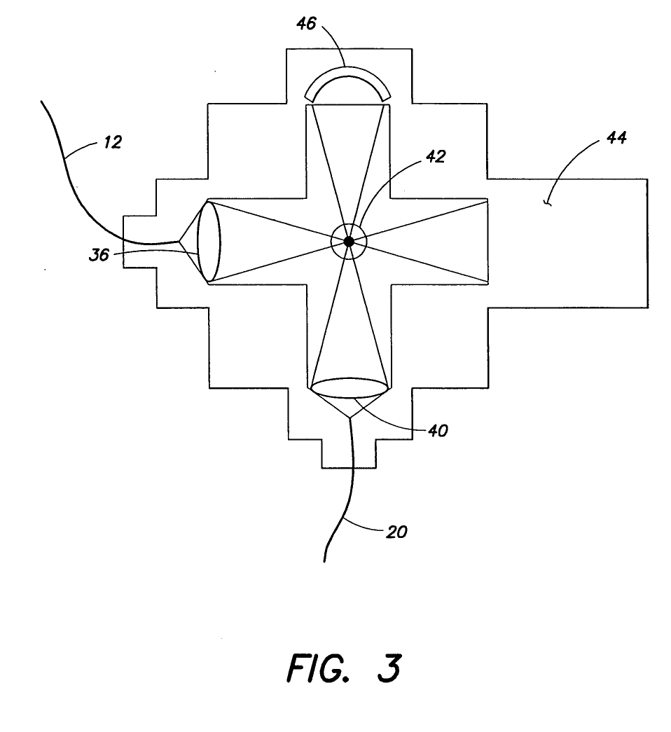

As shown schematically in FIG. 3, flow cell 14 can have one or more excitation focusing devices such as focusing lens 36 that can direct the energy directed through fiber 12 to a particular desired region 42 to increase the likelihood of interaction with the particle or particles under analysis. Flow cell 14 can further comprise one or more collection systems such as collection lens 40 that directs emitted response energy, e.g., a composite emission decay profile, to fiber 20. Flow cell 14 can further comprise a beam dump assembly 44, typically disposed distant from focusing lens 36, to capture energy not absorbed, or scattered. Further, flow cell 14 can comprise one or more retroreflectors 46 to facilitate direction of a response to collection lens 40.

Non-limiting examples of suitable excitation devices include a SURELITE™ I quadrupled YAG laser with a laser emission at 266 nm, available from Continuum, Santa Clara, Calif.; a quadrupled YAG microchip laser with a laser emission at 266 nm, available from JDS Uniphase Corporation, San Jose, Calif.; a nitrogen laser with an emission at 337 nm; a modulated diode laser system with a laser emission at 375 nm or 405 nm, available from Becker & Hickl GmbH, Berlin, Germany; and a tripled Ti:Sapphire laser with tunable output in the ultraviolet regime.

In accordance with one or more embodiments, the systems and techniques of the invention can comprise or utilize a suitable flow cell for detection of emitted light from an aerosol sample. The flow cell may comprise, for example, an enclosed space formed by the intersection of three tubes or boreholes or channels, preferably, along three orthogonal axes. The excitation energy can be introduced along one axis by, for example, suitable optics or optical devices so that it can be concentrated in the interaction region. The detection optics can be placed along the second axis so that the emitted energy can be transmitted or reflected into one or more detectors. A concave retroreflector may be placed opposite the detector to increase the light collection efficiency, preferably when a single detector is utilized. The airstream containing the particles, and optionally an annular flow of particle-free sheath air, can be introduced isokinetically along the third axis.

Any suitable detector can be utilized in the systems and techniques of the invention to measure a composite emission decay profile. The detector can measure a specific wavelength, a portion of the emitted spectrum, or, in some cases, the entire measurable spectrum. The detector should have a suitably rapid response time, for example less than 5 nanoseconds or preferably less than 500 picoseconds. Non-limiting examples of suitable detectors include a model 1P28 photomultiplier tube, available from Hamamatsu Photonics, K.K., Hamamatsu City, Japan; a model APM-400 avalanche photodiode module available from Becker & Hickl GmbH; a model PMC-100 photomultiplier module also available from Becker & Hickl GmbH; and a streak camera also available from Hamamatsu Photonics, K.K.

In accordance with one or more embodiments of the invention, the signal representing the composite emission decay profile can be obtained by a spectroscopic method preferably having time resolution, such as 100 picoseconds (ps) to distinguish different components of the decay. For example, a time-correlated single photon counting (TCSPC) technique may be utilized or other techniques that record low level light signals with, preferably, picosecond domain time resolution.

The response, typically corresponding to a measured response to the initiating or exciting energy can be represented as a signal, which can be sent to one or more analytical devices or systems. Suitable devices or system components include, for example, a digitizing oscilloscope with minimum bandwidth of 500 MHz such as a model TDS 3052 oscilloscope available from Tektronix, Inc., Beaverton, Oreg.; a computer interface card, such as a general purposed interface board (GPIB), USB, or RS-232 interface; a computer preferably utilizing a PENTIUM®-based microcomputer or a “palmtop” or personal digital assistant computer; instrument control systems such as MATLAB,™ IGOR PRO,™ LABVIEW,™ or other custom software and/or hardware packages; and waveform analysis application software packages such as MATLAB,™ IGOR PRO,™ SIGMAPLOT,™ or other custom software or hardware.

In accordance with one or more embodiments pertinent to some aspects of the invention, the analytical device typically evaluates the signal and decomposes it into substituent components. Preferably, the device can utilize one or more decomposition techniques to identify a scatter component and, if present, a fluorescence component. More preferably, the device can also utilize techniques, such as those based on deconvolution, to identify a non-biological component, and, if applicable, a biological component, of the composite response or the fluorescence component thereof. In some cases, the response and corresponding signals can comprise one or more scatter components and/or one or more fluorescence components. In still other cases, the fluorescence component can comprise one or more biologically-corresponding or biological component and one or more nonbiologically-corresponding or non-biological component. The deconvolution techniques can be performed until derived results have sufficiently converged compared to the measured signal. Such convergence criteria can be tailored to particular requirements.

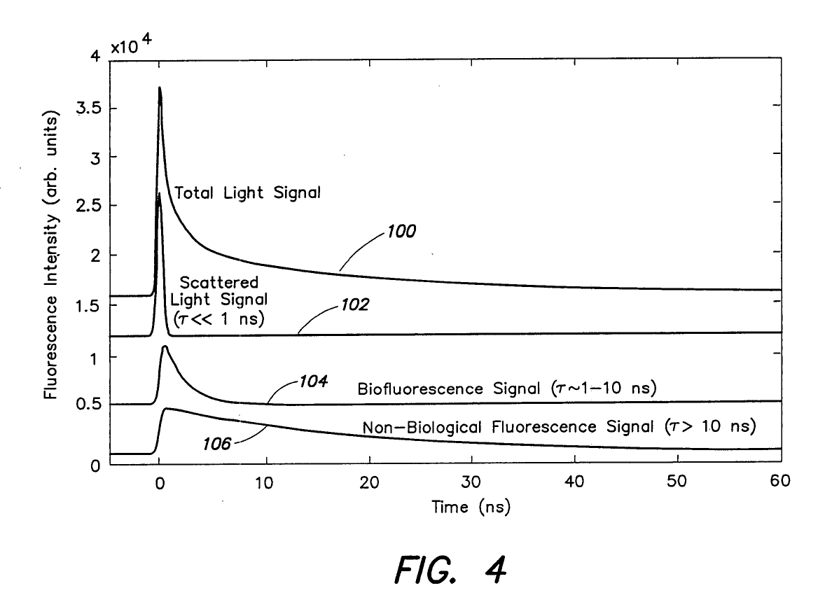

Signal decomposition techniques can be used to deconvolve the signal to obtain very fast, fast, and slow decay components, each of which can be characterized by decay constants on the order of picoseconds, nanoseconds, and tens of nanoseconds, respectively. FIG. 4 shows deconvolved components from the total or composite response measured as a composite emission decay profile in FIG. 1. FIG. 4 exemplarily shows a total response signal 100 comprising a scatter component 102, typically associated with an exciting energy and can be considered reflected, scattered energy from, for example, illuminated particles. In FIG. 4, the scatter component is shown with a Gaussian profile that may arise from the time profile of the excitation energy, e.g., the laser pulse. However, the scatter component will typically have the profile of the Instrument Response Function, discussed further below. The response can further comprise a biological component 104, typically having an exponential emission decay profile and a non-biological component 106, also typically having an exponential emission decay profile. As described, non-biological component 106 typically has a longer duration profile relative to biological component 104. By separating the signal components according to their decay characteristics, the biological fluorescence can be distinguished from non-biological fluorescence and from scattered light. Thus in accordance with some aspects of the invention, systems and techniques that utilize signals that can be recorded with a single photodetector, without dispersion or filtering, e.g., by wavelength, of the signal.

A filter may be utilized, at the excitation wavelength, to reduce the scattered light intensity component, which can be advantageous because the scatter component typically has a greater magnitude than the magnitude or contribution attributable to biological and/or non-biological fluorescence. The filter may comprise a long-pass or band-pass filter, which, preferably, selectively compensates for the excitation wavelength.

The composite intensity decay profile can be characterized as a sum of terms including S, the scattered light pulse, and n fluorescence decay terms Iₙ. The scattered light pulse profile is typically influenced by the distribution of ray lengths from the excitation source to the detector, and may be considered sufficiently narrow that it may be assumed to have zero width, relative to elapsed time. Intensity decays can therefore be represented as Iₙ=I_{o,n}e^{-(t/τn)}. Additionally, each term is typically convolved with the Instrument Response Function (IRF), which arises from the laser pulse shape and other aspects of the optical system and detector electronics. The IRF is determined via reflected or scattered light, where it is assumed that the only contribution is the shape of a reflected or scattered light pulse is the IRF. This determined IRF can be used during the deconvolution process.

A time constant τₙ can be respectively associated with each of the n biological and non-biological fluorescence decay components. Notably, one or more time constants, corresponding to one or more exponential profiles, can comprise each of the biological and the non-biological components.

Deconvolution of the different decays allows the fluorescence to be grouped into short and long lifetime bins or subcomponents. As exemplarily shown in FIG. 4, more than half of the total fluorescence (area under the curve) detected between about 1 ns to about 7 ns can be due to non-biological sources, such as PAH compounds, in the gas phase and/or adsorbed on bioaerosol particles. Deconvolution can be performed by utilizing statistical curve-fitting techniques to identify the scattering component, the non-biological components and the biological components. These statistical techniques typically construct a trial, e.g., an initial, composite decay profile using initial guesses for the intensity and decay parameters. Initial guesses are based on physical expectations about the sample being characterized. The parameters are typically varied to minimize the difference between the constructed composite decay profile and the composite decay profile. The vector of parameters that reduces the difference between constructed and measured profiles below some predetermined tolerance, usually within a predetermined maximum elapsed time, is chosen as best representing the components of the measured composite decay profile.

Examples of a suitable algorithm for curve-fitting that can be utilized to provide a characterization of the components include, but are not limited to, the Levenberg-Marquardt method or variants thereof. Non-limiting examples of software applications containing or utilizing the Levenberg-Marquardt algorithms or other suitable curve-fitting algorithms include, but are not limited to, IGOR PRO,™ SIGMAPLOT,™ MATLAB,™ and FLUOFIT™ as disclosed by, for example, J. Enderlein and R. Erdmann in “Fast Fitting of multi-exponential decay curves”, Optics Communications 134(1-6), 1997, pp. 371-378.

The intensities corresponding to the scatter, total biological fluorescence, and total non-biological fluorescence may be determined by summing all intensities for components with lifetimes within a certain range. For example, biological fluorescence could be taken as the sum of all intensities for components with lifetimes between about 0.1 and about 7 ns. Likewise, non-biological fluorescence could be taken as the sum of all intensities for components with lifetimes greater than about 7 ns. However, the lifetime ranges used to classify emission as scatter, biological fluorescence, or non-biological fluorescence may be chosen based on one or more factors including physical insights about the system being measured, lifetimes published in the scientific literature, and laboratory measurements of test particles. In some cases, the classification separation between biological and non-biological fluorescence can be varied as necessary to accommodate region or environment specific requirements. Thus, the biological components can be classified as those having time constants between about 0.1 ns to about 7 ns and, correspondingly, non-biological components can be classified as those having time constants greater than about 7 ns.

The total scatter and fluorescence intensities can thus define a discriminating vector comprising n-dimensional components corresponding to one or more of the scatter component, the biological components, and the non-biological components. Typically, the discriminating vector provides a characterization of the nature of the sampled aerosol particles in a three-dimensional map.

In some embodiments of the invention, the fluorescence intensities can be normalized by dividing by the scatter value. This can reduce the number of vector components by a degree of freedom to, for example, two, so a two-dimensional map can be used to provide a characterization of the nature of the analyzed sample of aerosol particles.

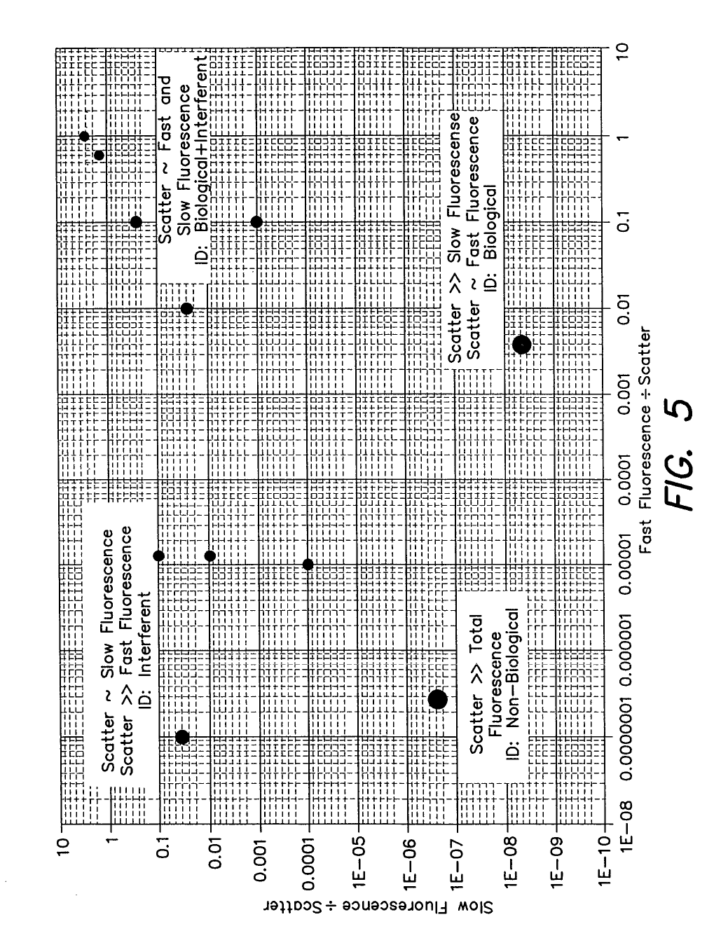

For example, once the decay rates of the different signal components have been characterized, the corresponding, associated initial response values may be plotted on a map that aids in discriminating between biological and non-biological signatures. FIG. 5 shows an example of where various aerosol types may be found on a map comparing normalized fluorescence intensities and scattering intensity. As exemplarily shown in FIG. 5, toward the right side of the map, the fast intensity component, typically associated with biological fluorescence can be equal to or greater than the slow intensity, which indicates that biological species are probably present. In some cases, scattering intensity can be represented by the size of the spot; if large, it can indicate a large particle size. Scatter intensity may be used, as is done with, for example, BAWS Tier III, as a proxy for size, so that intense fluorescent scattering species are probably large pollen grains, while very weak fluorescent scattering species may be submicron soot aerosols or fragments of bioparticles. Measurements of known aerosol types may be utilized to populate such maps and, preferably, provide delineating boundaries between biological and non-biological aerosols.

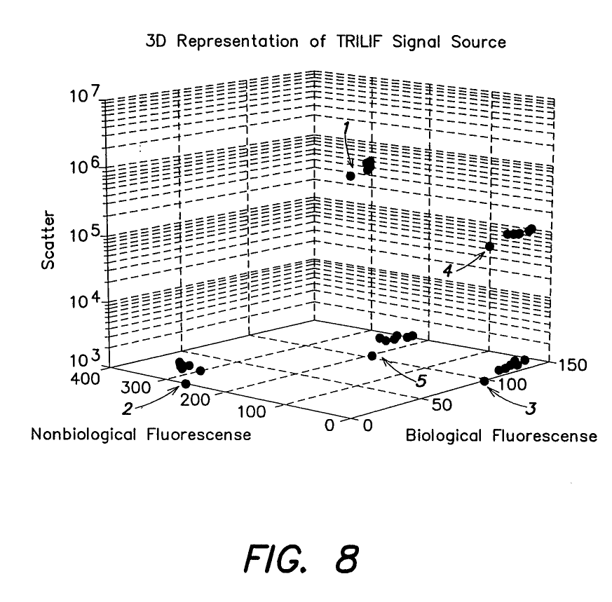

Other methods of analyzing the data to produce classification criteria can be utilized in accordance with the systems and techniques of the present invention. For example, Fourier transformation of the time domain data can yield a spectrum of decay frequencies that can be associated with the decay times. It is also possible to characterize particles based on the ratio of non-biological fluorescence to biological fluorescence, with or without normalization to scattering. Further, maps similar to that presented in FIG. 5 may be generated for other classification criteria, see for example FIG. 8, which is discussed in the examples.

In some cases, it is possible to combine the time-resolved detection method with other techniques such as those pertinent to dispersed or filtered fluorescence, to obtain both time and spectral information about the measured response. This can yield additional information about the fluorescing species or molecules. For example, the manner by which the fluorescence spectrum changes over time may indicate spectral relaxation, which can be indicative of how quickly a molecule's environment adapts to photonically induced changes in the molecule's electric field. Spectral relaxation can be dependent on the viscosity and polarity of the molecule's environment; thus, it may be a way of differentiating a molecule adsorbed on a solid surface, from a molecule embedded in a biological membrane, from a molecule in a liquid environment, e.g., cellular cytoplasm. This may allow detailed identification of classes of biological agents, because, it is believed, bacterial spores typically have little or lower water relative content.

Aerosol particles, entrained in airflow, can be excited, for example, one at a time, by pulsed laser radiation, light, at a wavelength that produces fluorescence from biological fluorophores such as tryptophan, tyrosine, NADH, or flavin compounds. Said particles also scatter said radiation to produce a scattered light pulse. Both fluorescence and scattered light can be detected by the same detector. This produces a signal pulse similar to that shown in FIG. 4. The measured signal corresponding to a response can comprise scattered light components and one or more of particle-bound biological fluorophore components and particle-bound, non-biological organic fluorophore components, and, in some cases, gas phase, non-biological organic fluorophore components, in the excited or illuminated focal region.

In accordance with one or more embodiments of the invention, the signal can be obtained by sampling at predetermined and/or strategic intervals using, for example, a spectroscopic method to distinguish different components of the decay. For example, a suitable method can comprise time-gated photon counting, but other methods may also be suitable.

Preferably, the excitation energy, e.g., laser beam, has a pulse width sufficiently small that the scattering signal decay can be distinguished from a 1 ns emission decay profile. A suitable pulse width can be about less than about 500 ps.

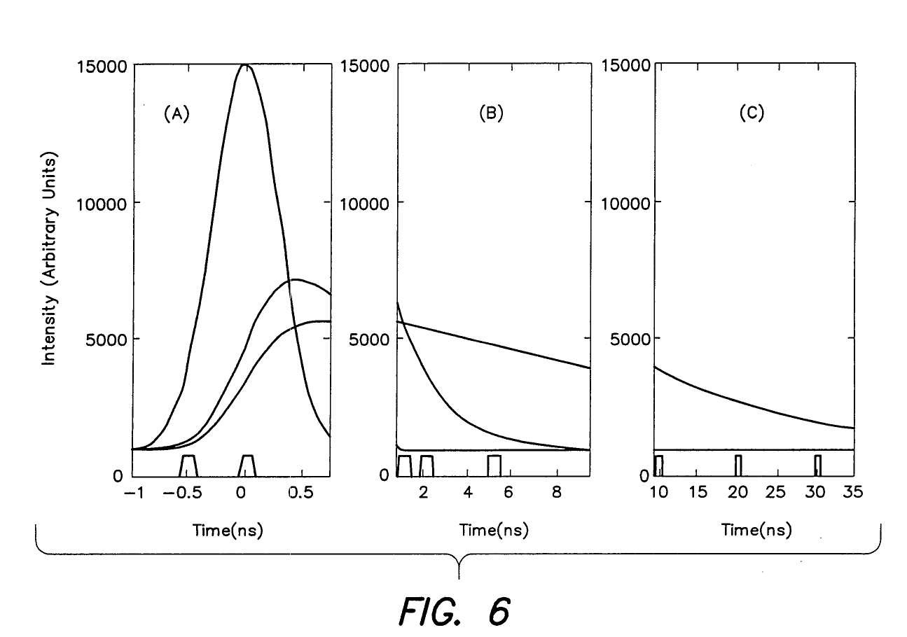

The gate start times and gate widths are chosen to sample the light intensity at times when most of the light is due to one source or another. FIG. 6 shows how gate times can be selected. The signals can be considered to be corresponding components exemplarily shown in FIG. 4, labeled as very fast scatter component 102, fast biological fluorescence component 104, and slow non-biological fluorescence component 106. As exemplarily shown, the signal traces can be offset from zero for clarity. The gate pulse is shown in the bottom trace, where a high gate signal corresponds to a period during which the detector is on or activated, and a low value corresponds to a period during which the detector is off or inactive. FIG. 6 exemplarily shows three panes to indicate events occurring on different time scales. For example, in (C), the gates, set at about 10 ns, 20 ns, and 30 ns, receive response measurements associated with long-lived, typically non-biological, fluorescence. Fluorescence intensities at such points may thus be used to estimate the contribution from non-biological fluorescence. In (B), gates, set at about 1 ns, 2 ns, and 5 ns, receive response measurements can be associated with long-lived fluorescence, which would preferably be subtracted based on the preceding analysis pertinent to long-lived, typically non-biological, fluorescence, and/or short-lived, typically biological, fluorescence. In (A) at a time from about −0.5 ns to about 0 ns, after compensating for estimated fluorescence, as determined above, the remaining detected light can be attributed to scattering of the exciting energy, e.g., the laser. Gate activation periods can be relative to the center of an excitation energy discharge but can be measured relative to the trigger that initiates the excitation energy discharge. Gate positions can be optimized based on data from environmental and test aerosols.

The three measured categories can then be used to map the data as shown in FIG. 5. Likewise, the position on the plot can be indicative of the nature of the sampled aerosol particles, e.g., whether the fluorescence is biological, non-biological, or both. Other mapping techniques can utilize ratios of short and long lifetime fluorescence components relative to the scatter component and provide a two-dimensional map as well as computing the ratio of short-lifetime fluorescence to long-lifetime fluorescence and plotting the ratio relative to scatter to also provide a two-dimensional characterization of the nature of the particles. Further, statistical and/or geometric techniques can be utilized to, for example, assign probabilities as to the nature or likelihood of biological or non-biological character of the particles. For example, statistical techniques can be utilized to assign a probability or likelihood that the particle is or comprises a target microorganism. Likewise, geometrical techniques can be utilized to assign distances representative of the character of the particle relative to one or more categories. For example, separation distances can be determined for a measured, analyzed discriminant vector relative to vectors of one or more known particles. The relative separations can thus be viewed as a likelihood of presence, likelihood of result, and/or likelihood of contribution.

Binary logistic regression can be utilized to provide particle classification. Other analytical techniques used for modeling complex relationships may also be utilized. Further, statistical techniques that provide a indication or probability of character, i.e., a probable value such as Multinomial Logit, if more than two response levels are identified; Discriminant Analysis, Cluster Analysis, Principal Component/Factor Analysis, and Bayesian methods, in which prior subjective probability distributions may be specified, if appropriate, may also be incorporated to provide characterization. Since the derived model(s) must be reliable predictors, it may be advantageous to demonstrate and quantify the predictive capability of each candidate by estimating false positive and false negative classification rates under various conditions or for particular candidate analytes.

Further aspects of the invention can involve multi-wavelength excitation systems and techniques. Thus, in accordance with one or more embodiments of the invention, a plurality of excitation devices that can be utilized to direct, for example, electromagnetic energy at a plurality of wavelengths. The response or emission spectrum can be analyzed. Various systems and techniques can be utilized to collect or gather the emission spectrum. For example, a plurality of detectors can be utilized to collect the emission spectrum. Some embodiments, however, may utilize a collection device configured to receive one or more particular wavelengths or one or more ranges of wavelengths. For example, a single detector having a wavelength selection device such as a grating or a filter, which is typically temporally selectable, can be utilized to collect the emission spectrum.

In embodiments utilizing a plurality of excitation wavelengths, excitation can be performed at any desired wavelengths. Typically, one or more of the plurality of wavelengths utilized are selected to provide a response or emission that corresponds to one or more particular or target bioparticles, bioaerosols, or excitable components and/or derivatives thereof and can include proteins, nucleic acids, as well as cofactors thereof. For example, the one or more wavelengths can be selected to provide an excitation condition of tryptophan, tyrosine, phenylalanine or other compounds which may exhibit intrinsic fluorescence such as, but not limited to the cofactors FMN, FAD, NAD, and porphyrins. In some cases, however, especially where functional groups may behave as fluorophores, the excitation wavelengths may be accordingly selected.

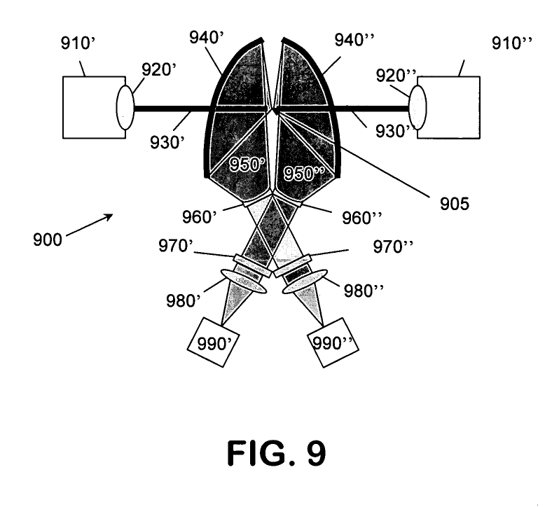

FIG. 9 is a schematic illustration that exemplarily illustrates a detector in accordance with further aspects of the invention. Such aspects may be practiced as multi-wavelength detector embodiments involving a combination or a plurality, typically different, optical components. Certain embodiments of the invention involve components that differ based on a plurality of consideration including, for example, on the source of excitation energy, e.g., whether a laser or an LED provides any excitation energy and, in some cases, the anticipated character of the analyte. For example, a laser may generate sufficient light signal so that a photodiode can be used as the detector, thereby reducing any reliance on photomultiplier tubes.

The high-efficiency detector illustrated in FIG. 9 can comprise one or more optical systems configured to utilize multi-wavelength excitation spectrometers. The detector 900 is exemplarily illustrated utilizing a first wavelength and a second wavelength. Thus, the detector, in some cases, can be embodied as utilizing a first wavelength subsystem and a second wavelength subsystem.

The first and second wavelength subsystems can comprise a first radiation source 910′ and a second radiation source 910″. First and second radiation sources 910′, 910″ can comprise one or more monochromatic pulsed light sources such as but not limited to, lasers, LEDs, configured to operate or provide excitation energy at a desired, preferably, single wavelength, or at a first desired wavelength range. If the one or both subsystems are configured to provide a wavelength range, the size or magnitude of the range preferably provides a narrow band of excitation energy. Radiation sources 910′, 910″ typically each include control subsystems, e.g., electronics and/or software that facilitate operation of the energy source. Control of the subsystems can be effected utilizing combined or separate control systems. The first and second wavelength subsystems can further comprise one or more optical delivery subsystems 920′, 920″ that can refine the first and second excitation energies to have one or more desired characteristics. For example, one or both of the excitation radiation can be modified to have a desired wavelength band, a target focal distance, and/or other characteristic, such as a desired intensity. Optical delivery subsystems 920′, 920″ can thus collimate, filter, or otherwise modify one or more characteristics of the excitation energies. Optical delivery subsystems 920′, 920″ can comprise one or more optical elements, such as lenses, mirrors, filters, prisms, in a variety of arrangements and configurations which respectively results in a first excitation light beam 930′ and a second excitation light beam 930″. First and second light beams interact with an analyte, such as particle 905, typically disposed within a particle stream and preferably traveling perpendicularly relative to an axis defined by first and/or second excitation beams 930′, 930″. Each of the light beams interacts with particle 905 and produces corresponding emitted radiations as light emissions 950′ and 950″, respectively.

The emitted radiations typically result from due to scattering phenomena and, for some analytes, luminescence phenomena. The respective light emission can be collected by a first collection optical subsystem 940′ and a second collection optical subsystem 940″. First and second collection optical subsystems 940′, 940″ can comprise one or more components that are arranged and/or configured to collect and/or direct the emitted radiation responses. Examples of components of the collection subsystems include, but are not limited to, off-axis ellipsoidal mirrors, as shown, as well as paraboloidal mirrors or hybrids thereof. The collected responses are typically each directed into one or more collimating optical subsystems 960′ and 960″ that can render the collected response energy into collimated beams, of appropriate diameter, and can further direct the collimated responses to one or more filtering elements such as first filter assembly 970′ and second filter assembly 970″. First and second filter assemblies 970′, 970″ typically reduce the intensity of the scattered excitation component preferably without altering the luminescence component. For example, first and/or second filter assemblies 970′ and 970″ can comprise one or more optical components such as but not limited to, filters as shown, dichroic mirrors, and/or fixed gratings.

Optionally, the collimated and filtered light passes through one or more focusing optical trains such as first focusing optical train 980′ and second focusing optical train 980″. As illustrated, the focusing optical trains can comprise one or more mirrors or lenses. The respective direct light responses typically impinge on one or more detector subassemblies such as first detector assembly 990′ and second detector assembly 990″ which can render the response into respective electronic signals. Preferably, each of the detector subassemblies has a response time that provides corresponding signals that sufficiently represents the characteristics of the emitted energy. Thus, in accordance with one or more embodiments of the invention, the response characteristics of the detector subassemblies are in the order of nanoseconds. Further, the detector subassemblies have sufficient sensitivity to detect the single-event, e.g., a single-particle response. Thus, in some cases, the detector subassemblies may comprise one or more photomultiplier components.

Typically, the detector assemblies are synchronized with the corresponding radiation sources. For example, one or more detector assemblies in the first wavelength subsystem is triggered to measure during activation of the one or more radiation sources of the first wavelength subsystem. In some cases, the first and second wavelength subsystems are activated alternately, e.g., interleaved, so that when the first radiation source is energized, the first detector assembly is active and the second radiation source and the second detector assembly are inactive. Likewise, when the second radiation source is energized, the second detector assembly is active and the first radiation source and the first detector assembly are inactive. Thus, an alternating ON and OFF mode of operation may be utilized.

Alternatively, a filter selector capable of operating at about 50 KHz can be utilized to selective separate the emitted responses. For example, a piezoelectrically-controlled mirror can be operated in phase with both LED driver signals thereby diverting the emitted fluorescence beams between two small, closely spaced filters. Alternatively, fluorescence light falls on both filters, and a saturatable absorber, which can be activated optically or electrically, alternately blocks one of the two filters.

LED light sources with sufficiently narrow pulse width with sub-nanosecond pulse widths are commercially available from PicoQuant GMBH, Berlin, Germany, and from HORIBA Jobin Yvon Inc., Edison, N.J. However, the invention need not be limited to radiation sources having narrow pulse widths. Indeed, the invention may utilize radiation sources, such as LEDs, that provide fast or rapid changes in delivering and extinguishing excitation energy. For example, LEDs having very fast ramp rates to full power, e.g., about 2 ns or less, and very fast cutoffs, e.g., 2 ns or less, may be utilized even is the total pulse duration is about 20 ns. The very fast rise and fall times can improve characterization by providing improved signal contrasting.

While a single-wavelength time resolved system can distinguish between biological and PAH fluorescence, distinguishing between different types of bioaerosols, e.g., with or without PAH, may require spectral resolution. For example, resolution of the emission spectrum using dispersion elements and multiple detectors or resolution of the absorption spectrum, which may utilize multiple light sources, may characterize the nature of the bioaerosol analyte. Multiple detectors sensitive enough to detect single-particle fluorescence are relatively expensive but the development of deep-UV LED light sources from, for example, Sensor Electronic Technology Inc., may reduce the cost of systems that utilize multiple light sources at different wavelengths. Nonetheless, the present invention may utilize any of these systems.

Bioparticles typically contain two strongly fluorescent chromophores which absorb at well-separated wavelengths; tryptophan exhibits an absorption maximum near 280 nm and NADH exhibits an absorption maximum near 340 nm. Since different biological species and different states of a single species lifecycle have different concentrations of tryptophan and NADH, the systems and techniques of the present invention may be utilized to incorporate relative fluorescence techniques, based the measured responses of these two species, to characterize the nature of the bioparticle analyte and, in some cases, to distinguish different types of bioparticles.

Discrimination algorithms can be utilized to provide such characterizations. For example, a polynomial discrimination function can be generated based on measured responses emitted from known bioaerosols. The discrimination function can then be utilized to distinguish between biological and non-biological analytes.

The functions and advantages of these and other embodiments of the invention can be further understood from the examples below. The following examples illustrate the benefits and advantages of the systems and techniques of the invention but do not exemplify the full scope of the invention.

### EXAMPLE 1

### Prophetic Characterization System

Prophetic data can be generated for several types of particles; non-fluorescent particles (scattered light only); particles containing a mixture of common atmospheric PAHs having representative lifetimes about 15, about 22, and about 30 ns; hazardous bioaerosols (respirable bioparticles) having a representative lifetime of about 2 ns; background bioaerosols (e.g., a pollen grain) having a typical lifetime of about 2 ns.

This prophetic example data is constructed to approximate the results expected from one example implementation of the present invention. The experimental system can comprise a quadrupled SURELITE I™ YAG laser emitting at 266 nm available from Continuum, Inc., and a flow cell comprising about two-inch cubic aluminum block bored through on three orthogonal axes. Aerosol particles are introduced isokinetically within an annular, particle-free sheath flow, wherein the aerosols interact with the emitted laser energy in a central interaction region. Emitted radiation from the sample of aerosol particles or reflected by a retroreflector is collected by a collection optical system. Excess laser light that is not absorbed or scattered by the sample of aerosol particles is captured by a beam dump disposed distant from a laser focusing lens. A silica/silica optical fiber cable conducts the emitted laser energy to the cell and a second silica/silica optical fiber conducts the response from the cell to the detector, both optical fibers are model FVA available from Polymicro Technologies, LLC, Phoenix, Ariz. Optionally a monochromator, such as those available from Jarrell Ash Corp./Thermo Electron Corp., Woburn, Mass., or other similar device can be utilized to select a single emission wavelength for detection. The system can further comprise one or more photomultiplier modules such as a model 1P28 photomultiplier tube available from Hamamatsu Photonics, K.K., Hamamatsu City, Japan; a model TDS 5032 digitizing oscilloscope available from Tektronix, Inc., Beaverton, Oreg., to enhance or amplify the response; a computer comprising a PENTIUM® microprocessor with a general purpose interface board (GPIB) running LABVIEW™ software, available from National Instruments Corporation, Austin, Tex., to control the system and/or record and analyze data. Data analysis can be performed utilizing commercially or otherwise freely available software from for example MATLAB™ available from MathWorks, Inc., Natick, Mass. and/or FLUOFIT™ software for deconvolving composite emission decay profiles by performing, for example, multi-exponential least squares fitting.

The specific hardware configuration chosen to make the fluorescence measurements determines the Instrument Response Function (IRF). The IRF is a temporal function that alters the expected exponential decay profiles in a manner equivalent to mathematical convolution. Therefore, if the IRF for a given experimental configuration is known, it is possible to predict the approximate form of the signal that will be recorded from a particle of specified size and composition.

Further, the IRF for a given experimental configuration can be recorded by measuring the time-dependent intensity profile of a light pulse reflected from a mirror or any convenient, non-fluorescing surface. Therefore, it is possible to construct a prophetic data set relating to a particle of specified size and composition, as measured by a spectrometer of specified hardware configuration. The basic component of a time-domain fluorescence signal is an exponential decay, Ie^{(-t/τ)}, where I is the intensity and τ, the fluorescence lifetime. Individual signals for scattered light, and fluorescence with lifetimes characteristic of biomolecules and common PAHs, are summed to construct the ideal decay profile. The recorded IRF for the spectrometer in use is convolved with the ideal decay profile to produce a prophetic decay profile for the specified particle and experimental system.

### EXAMPLE 2

### Analysis of a Prophetic Response

FLUOFIT™ software was used to analyze a convolved representative response to derive up to three exponential decay components and one scatter component. The resultant of this was a set of intensities and lifetimes that characterize different components of the decay. Intensities for short-lived fluorescence were summed and taken as representative of biofluorescence. Intensities for long-lived fluorescence were summed and taken as representative of PAH fluorescence. The IRF intensity was taken as representative of scattered light, which is typically related to particle size. The short- and long-lived fluorescence totals and scattered light total were used to locate the particle on a three-dimensional map to classify the various particles.

Table 1 lists exponential decay parameters of representative species that may be encountered. For PAHs, the “relative importance” (RI) is a measure of the importance with respect to fluorescence measurements, compared to biomolecules. The calculation was performed as follows: published measurements of concentration in atmospheric gas/particulate phase were used to estimate gas or surface concentration of the PAH in question. Particles sizes of 2 μm diameter were utilized. Fluorescence emitted by the PAH was calculated based on the above concentration, multiplied by the absorption cross section and fluorescence quantum yield. The total fluorescence emitted from a 2 μm Bacillus Atropheaus spore was estimated based on measurements from several laboratories.

PAH fluorescence was normalized relative to Bacillus Atropheaus spore fluorescence to give the RI score. Of the 39 compounds found in the atmosphere by one environmental study, only five have RI of 0.1 or more. Of these, all but two have lifetimes longer than expected for bioparticles.

Representative exponential decay parameters were determined. The values used in this prophetic dataset relate to the Relative Importances and Lifetimes (listed in Table 1) and are listed in Table 2.

Five particle signals were constructed and listed in Table 3. The first particle representation corresponds to a dust grain having no fluorescence aspect. The second particle representation corresponds to a 2 μm diameter particle having PAH #1, 2, and 3 aspects. The third particle representation corresponds to a 2 μm diameter spore having a fluorescence time constant of about 2 ns. The fourth particle representation corresponds to a 20 μm diameter pollen with a fluorescence time constant of about 2 ns. The fifth particle representation corresponds to a microbial spore contaminated with PAH 1 and 3.

TABLE 1
Known atmospheric gas phase or particulate fluorophores along
with estimated time constants (presented as lifetimes) as well as their
estimated importance relative to Bacillus Atropheaus fluorescence.

| Aerosol Species | Relative Importance | Lifetime (ns) |
|---|---|---|
| Phenanthrene (gas phase) | 1.5 | 57.5 |
| Phenanthrene (particle) | 1.5 | 57.5 |
| Bacillus Atropheaus (2 μm dry spore) | 1.0 | 2 |
| Fluorene (particle phase) | 0.8 | 10 |
| Fluorene (air phase) | 0.6 | 10 |
| Naphthalene (particle phase) | 0.4 | 96 |
| C1-C4 Anthracenes (gas phase) | 0.4 | <6 |
| C1-C4 Anthracenes (particle phase) | 0.3 | <6 |
| Anthracene (particle phase) | 0.1 | <6 |

TABLE 2
Representative model fluorophores and scattering sources
along with typical time constants (presented as lifetimes) and
intensities in arbitrary units. These constituents were used to construct
the prophetic example signals.

| Compound Name | Intensity (arbitrary units) | Tau, τ (ns) |
|---|---|---|
| PAH #1 (phenanthrene) | 150 | 57.5 |
| PAH #2 (fluorene) | 80 | 10 |
| PAH #3 (C1-C4 anthracene) | 40 | 5 |
| Microbial Spore | 100 | 2 |
| Pollen Grain | 10,000 | 2 |
| Scatter from 2 um particle | 100 | 0 |
| Scatter from 20 um particle | 10,000 | 0 |
| Scatter from 100 um particle | 250,000 | 0 |

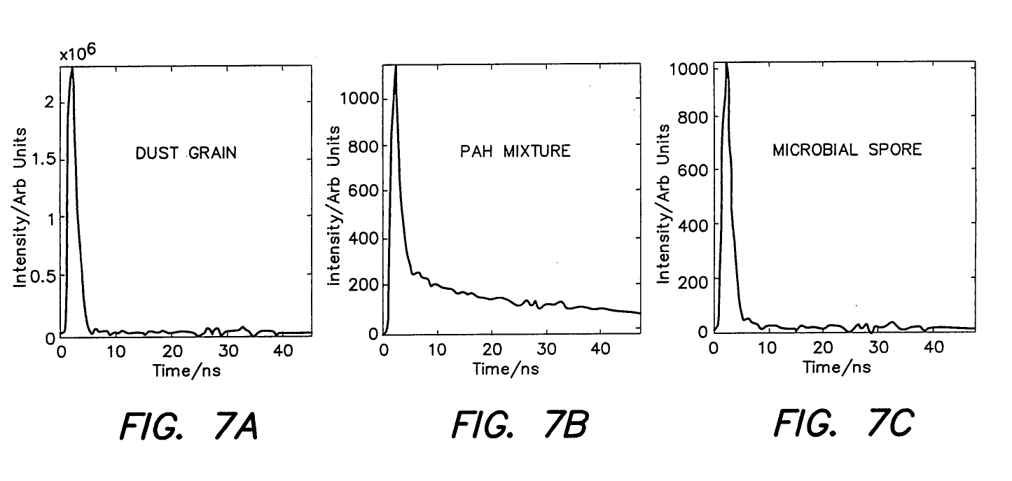

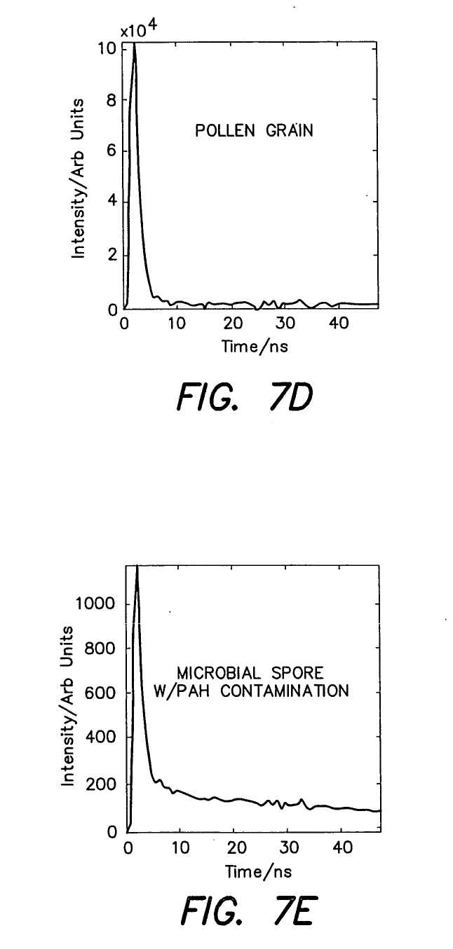

FIGS. 7A-7E show constructed decay profiles for each of these particles. FIG. 7A shows the constructed decay profile for the first particle, the dust grain. FIG. 7B shows the constructed decay profile for the second particle, a mixture of PAH 1, 2 and 3 on a 2 μm diameter particle. FIG. 7C shows the constructed decay profile for the third particle, microbial spore. FIG. 7D shows the constructed decay profile for the fourth particle, pollen. FIG. 7E shows the constructed decay profile for the fifth particle, spore with PAH 1 and 3 contaminations.

TABLE 3
Constructed particle description.

| | Size (μm) | | |
|---|---|---|---|
| Particle | Scatter | Fluorescent | Lifetimes |
| (Description) | Intensity | Intensity | (ns) |
| 1 | 100 | None | None |
| (Non-fluorescent dust grain) | 2,500,000 | | |
| 2 | 2 | 150, 80, 40 | 57.5, 10, 5 |
| (Mixture of PAH 1, 2 and 3) | 1,000 | respectively | respectively |
| 3 | 2 | 100 | 2 |
| (Microbial Spore) | 1,000 | | |
| 4 | 20 | 10,000 | 2 |
| (Pollen Grain) | 100,000 | | |
| 5 | 2 | 150, 40, 100 | 57.5, 5, 2 |
| (Microbial/PAH 1 and 3) | 1,000 | respectively | respectively |

The decay profiles shown in FIGS. 7A-7E were deconvolved with multiexponential, least squares fit to derive intensity and lifetime of each decay component.

Table 4 lists the derived results. As shown in Table 4, for each of the constructed decay profiles, the derived Fit Percentage (which is representative of the initial intensity) closely corresponded to the Actual Percentage for each of the components of each particle. Likewise, the derived Fit Lifetime closely corresponded to Actual Lifetime. For example, for particle 1, which was a dust grain having a scatter component and no fluorescence component, the derived Fit Lifetime was about 0.003, indicative of no decay component, no fluorescence component.

For particle 3, the deconvolution process identified a scatter component and a fluorescence component, the fluorescence component classified as biological because it had a lifetime (Fit Lifetime) of less than about 7 ns. The scatter component was derived to be about 91% (as Fit Percentage), closely corresponding to the Actual Percentage (91%). The fluorescence component was derived to have a Fit Percentage (8.7%) close to the Actual Percentage (9%). The derived Fit Lifetime (1.5 ns) also corresponded closely to the Actual Lifetime (2 ns). Thus, the results presented in Table 4 show that various prophetically constructed particles can be characterized by, for example, deconvolution, to provide components of a response from the particle.

### EXAMPLE 3

### Mapping Particle Characteristics

In this example, particle characteristics as represented by a discriminant vector were mapped according to their position in time-resolved fluorescence signal space.

FIG. 8 is a map showing the relative positions of each of the constructed particles analyzed in Example 2 with respect to a scatter component, a non-biological fluorescence component, and a biological fluorescence component. The discriminant vectors for each of the dust grain 1, PAH mixture 2, spore 3, pollen 4, and spore with PAH 5 were mapped.

As shown, the spatial groupings provided an indicating of the general composition of particle. Thus, the technique of mapping can be utilized to facilitate the characterization of the nature of particles based on the particle's deconvolved response. Other representative discriminant vectors have also been shown for comparison.

As discussed above, other mapping techniques can be utilized to characterize the nature of each particle. For example, it may be possible to compute the ratios of short- and long-lifetime fluorescence to scatter, and plot ratios in two dimensions or to compute the ratio of short-lifetime fluorescence to long-lifetime fluorescence, and plot the ratio relative to scatter in two dimensions. It may also be possible to analyze groupings using statistical and geometrical algorithms, without using a graphical representation.

TABLE 4
Deconvolution results.

| | | Actual | Actual | Actual | Fit | Fit | Intensity | Lifetime |
|---|---|---|---|---|---|---|---|---|
| Particle | Component | Intensity | Percentage | Lifetime | Percentage | Lifetime | error | Error |
| 1 | Scatter | 2,500,000 | 100 | 0 | 100 | 0.003 | 0 | 0.003 |
| 2 | Scatter | 1,000 | 79 | 0 | 88 | 0.04 | 9 | 0.04 |
| | PAH #1 | 150 | 12 | 57.5 | 6.2 | 57.5 | −5.8 | 0 |
| | PAH #2 | 80 | 6 | 10 | 3.9 | 9.86 | −2.1 | 0.14 |
| | PAH #3 | 40 | 3 | 5 | 0 | 4.77 | −3 | 0.23 |
| | Total | 1,270 | | | | | | |
| 3 | Scatter | 1,000 | 91 | 0 | 91.3 | 0.04 | 0.3 | 0.04 |
| | Bio | 100 | 9 | 2 | 8.7 | 1.5 | −0.3 | 0.5 |
| | Total | 1,100 | | | | | | |
| 4 | Scatter | 100,000 | 91 | 0 | 91.3 | 0.04 | 0.3 | 0.04 |
| | bio | 10,000 | 9 | 2 | 8.7 | 1.5 | −0.3 | 0.5 |
| | Total | 110,000 | | | | | | |
| 5 | Scatter | 1,000 | 78 | 0 | 86 | 0 | 8 | 0 |
| | PAH #1 | 150 | 12 | 57.5 | 6 | 57.5 | −6 | 0 |
| | PAH #3 | 40 | 3 | 5 | 2.2 | 4.9 | −0.8 | 0.1 |
| | Bio | 100 | 8 | 2 | 5.9 | 1.95 | −2.1 | 0.05 |
| | | 1,290 | | | | | | |

### EXAMPLE 4

### Example of a Bioaerosol Discrimation System Utilizing LEDs

The use of two sets of LEDs as light sources is described in this prophetic example and is exemplarily represented in FIG. 9.

A conceptual detector/discriminator system comprises the following components including two LEDs operating at 280 nm and two LEDs operating at 340 nm. Examples of which are commercially available as UVTOP®-280 and UVTOP®-340 LED devices from Sensor Electronic Technologies, Columbia, S.C. Each of the LEDs are operated to produce about 20 ns pulses at a rate of about 25 kHz, with a peak power of about 50 mW. Four LEDs, typically arranged in sequence, produces about 20 ns pulses at about 100 KHz with about 50 mW peak power, operated to interleave or alternate between wavelengths of 280 nm and 340 nm.

Optical bandpass filters are utilized to provide a ratio of emission, at the excitation wavelength (280 or 340 nm, respectively), of at least 1,000:1 compared to the corresponding peak emission wavelength, which is about 320 nm for tryptophan and about 420 nm for NADH, respectively.

An optical delivery system is utilized to focus the excitation LED beam into a cubic detector volume that is about 100 microns on each side. The cubic detector volume should be spatially coincident with the detector volume.

An inlet and particle flow assembly, with a focusing nozzle is configured to deliver about 1,000 particles per second to the cubic detector volume.

An optical fluorescence collector system collects of the emitted photons, typically about 25% of the total amount of photons. The collector system can comprise one or more integrating spheres and/or one or more ellipsoidal mirrors.

For each excitation wavelength emitted, at least one high speed detector capable of detecting single photons would be utilized. For example, a model H5773 compact photomultiplier module, with a rise time of less than 1 ns and a single-photon response, at about 320 nm, of approximately 1 mV when connected to a 50 ohm input, available from Hamamatsu Photonics, K.K. can be utilized. The detector assembly may be supplemented by one or more amplifiers to give a single-photon response of greater than about 100 mV and thus be suitable for photon counting. The configuration is commercially available from, for example, Becker & Hickl GMBH as model PMH-100 system.

An electronics module or system capable of integrating the photomultiplier signal in three to five time gate windows can be utilized in characterization. For example, the first time windows can be defined as between about 12 ns and about 22 ns; the next window can be defined to be between about 22 ns and about 29 ns; the third time window can be defined to be between about 29 ns and about 37 ns; the next time window can be defined to be between about 37 ns and about 62 ns; and the last time window can be defined to be from about 62 ns to about 146 ns. These would be relative to the start of the excitation pulse. In addition, the electronics module utilized would preferably accumulate signal in each bin across at least 50 LED pulses. In a particularly preferred embodiment, the electronics module would operate in photon counting mode to provide a single count for every recorded pulse higher than a set threshold so that the photon's energy and the PMT's pulse height distribution would not bias the results. The electronics module described here is a simplified version of a multiscaler card such as the model P7887 digitizer/multiscaler card from FAST Comtec GMBH, Oberhaching, Germany. In another preferred implementation, the module would integrate the absolute signal from the detector, which may over-count the signal from shorter-wavelength photons because these photons typically create relatively more intense PMT signals. Over-counting can be compensated by calibration of the system. The configuration may be advantageous because integrating the absolute signal should be less expensive than an implementation wherein single photons are counted. A conventional 500 MHz storage oscilloscope is an example of an absolute signal integrator.

Such a system would have sufficient sensitivity to measure fluorescence decays from biological particles as exemplified by 1 micron diameter B. Atrophaeus spores in the following calculation.

a. Single Pulse Excitation Power Density

The excitation flux for one pulse is about 50 millijoules per second for about 20 ns, into an area of 10⁻⁴ cm², for an excitation pulse power density of about 10⁻⁵ J/cm²/pulse.

b. Fluorescence Emission Per Particle.

The integrated fluorescence cross-section for B. Atrophaeus (also called B. Subtilis var. Niger) is about 5×10⁻¹³ cm²/spore. The emission is expected to have a maximum emission at about 320 nm (See G. W. Faris et al., Applied Optics, vol. 36 no. 4 pp. 958-67). Utilizing the excitation pulse power density as above, the fluorescence emission is expected to be about 6.1×10⁻¹⁶ J/particle (5×10⁻⁴ J/cm²/pulse times 5×10⁻¹³ cm2/spore times 25,000 pulses/particle times 1 particle every 10⁻³ seconds). About 25% of the emission would be collected by the optical system.

Photons of approximately 320 nm wavelength have about 6×10⁻¹⁹ J of energy. The collected flux should correspond to approximately 100 photons per particle. With a single photon detector, this should be sufficient to ensure that a good representation of the fluorescence decay curve is obtained.

c. Use of Multiple LEDs to Increase Signal per Particle.

Following the turn-off of the LED pulse, a delay may be necessary prior to the next “pulse off” event to ensure that no residual fluorescence from the previous event is present and/or detected. Because oxygen quenching typically shortens the lifetimes of most molecules in air, so that while some PAHs have lifetimes of greater than about 100 ns in degassed solution, lifetimes in the atmosphere are typically much less than 100 ns. Therefore, a delay of about 200 ns between “pulse off” events should be sufficient. This thus provides a maximum measurement rate of about 5 MHz. Commercially available components and systems typically have a pulse rate limit of approximately 25 KHz for one LED, but multiple LEDs of the same wavelength can be used to increase the effective pulse rate at that wavelength. In this example system two LEDs of each wavelength are thus utilized.

This example describes an embodiment of the invention that can be practiced with commercial, “off-the-shelf” technology, but one skilled in the art will recognize that custom engineering allows many approaches to address the limitations concerning power and particle flow rate. The 5 MHz maximum rate allows, for example, 100 LEDs operating at a wavelength of 280 nm and 100 LEDs operating at a wavelength of 340 nm to be sequentially pulsed. Since the four-emitter case is shown above to give sufficient signal for a single particle, the larger number of emitters allows the particle flow rate to be increased to 50,000 particles per second. The fraction of 280 nm and 340 nm excitation LEDs could also be adjusted to compensate for the lower fluorescence efficiency of NADH compared to tryptophan. Alternatively, a third group of LEDs operating at a third wavelength could be utilized. The third set of LEDs can operate at a wavelength near 400 nm to excite flavin compounds, thereby allowing better discrimination between different types of biological particles. The LED emitter size is quite small, so that while 200 complete LED packages would be cumbersome to build into a detector device, a custom LED package could be engineered that would contain a large number of independently addressable emitters.

### EXAMPLE 5

### Example of a System Utilizing Time-Resolved LED Induced Fluorescence

This example describes an LED-based system that can be used to discriminate between biological and non-biological materials.

The system of the example comprises an LED source with collimation and focusing optical component that focus the entire output of the LED into a detection volume with vertical cross-section 0.1 mm square. The LED is operated to provide about 20 ns pulses, having rise and fall times of about 2 ns. The LED source emits about 100 mW average power. A single pulse of the LED after the filter contains approximately 0.5 microjoule of energy. Such an LED is available from Sensor Electronic Technologies Inc, Columbia, S.C., as the Model UVTOP®-280 LED. Two LEDs are utilized to provide this power.

The system also comprises a particle inlet, a preconcentrator, and a focusing system that delivers particles at a rate no greater than 1,000 particles/sec into the detection volume. The particle stream is configured to be normal relative to the light beam axis.

The system also includes a fluorescence collection optical system that delivers about 25% of the emitted fluorescence and scattered light to a filter system. An example of such a system uses ellipsoidal reflectors and is diagrammed in FIG. 9.

The system includes a filter assembly that transmits 10⁻¹⁰ of incident light below a wavelength of 305 nm. Such a system may comprise two Corning WG305 glass plates, each approximately typically about 3 mm thick.

The system can also comprise a photon detector module capable of generating single-electron-response pulses sufficiently large to be registered by a photon counter. Such a detector module is available from Becker and Hickl GmbH as the model PMH-100 module.

The system can also comprise a multi-hit photon counter that can count photons in time bins of 10 ns or greater, at burst rates up to 20 photons in 2 ns. Such a counter is available from Fast Comtec GmbH as the model P7889 multiscaler card.

The system can further include a computer system capable of acquiring and recording signals from the photon counter at the particle arrival rate, typically about 1000 Hz. Computer systems with this capability are commercially available from, for example, National Instruments, Inc., Keithley Metrabyte, Inc, and other companies.

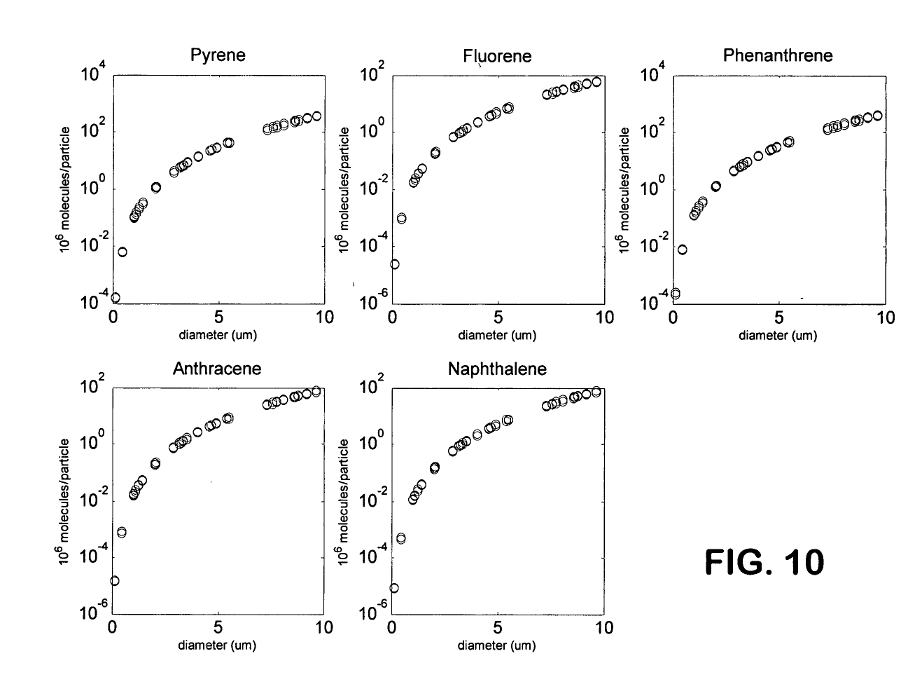

The calculations described in Example 4 above as steps a, b, and c, show that detecting signals from single Bacillus Atrophaeus spores using LED excitation can be achieved. A model of this system was used to generate predictive single particle signals for two particle types: Bacillus Atrophaeus clusters having diameters of between 1 micron and 10 microns and polystyrene latex spheres, with the same range of diameters. The simulated particles were coated with atmospherically common, semi-volatile polycyclic aromatic hydrocarbons using amounts consistent with the conventional bulk atmospheric measurements. Distributions of aerosol coating relative to particle size are shown in FIG. 10 for the six PAHs used, pyrene, fluorene, phenanthrene, anthracene, and naphthalene.

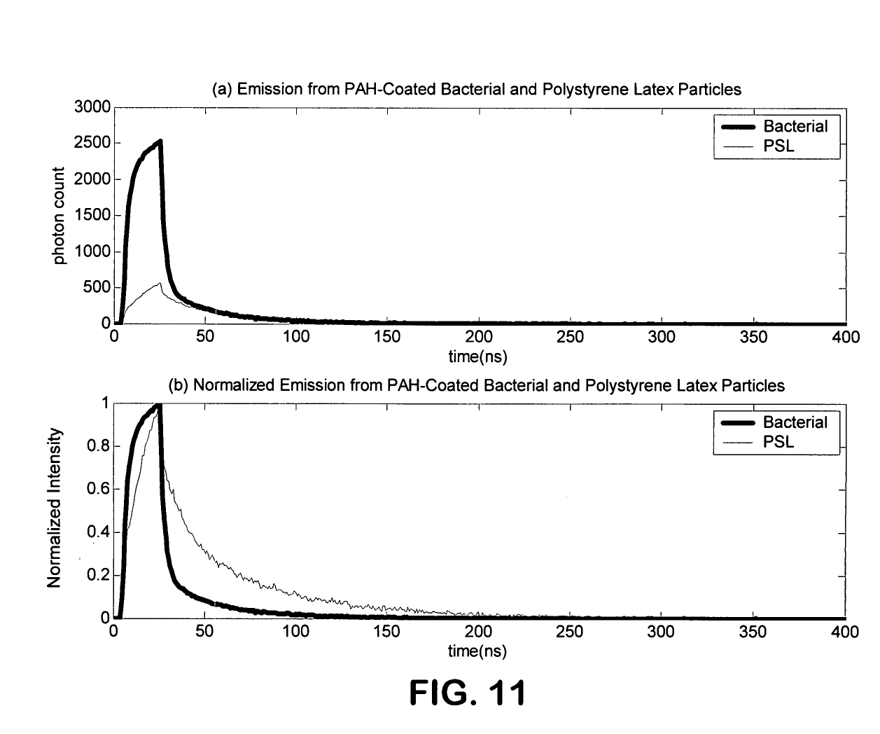

FIG. 11 shows the expected difference in decay curves between a PAH-coated bacterial cluster and a PAH-coated polystyrene latex (PSL) sphere. The particles in this example are assumed to have a diameter of 4.5 microns. In FIG. 11, the upper graph shows the predicted emission intensities and the lower graph shows the expected trace decay curves, after normalization relative to unit intensity, to emphasize the difference in behavior at later photon arrival times.

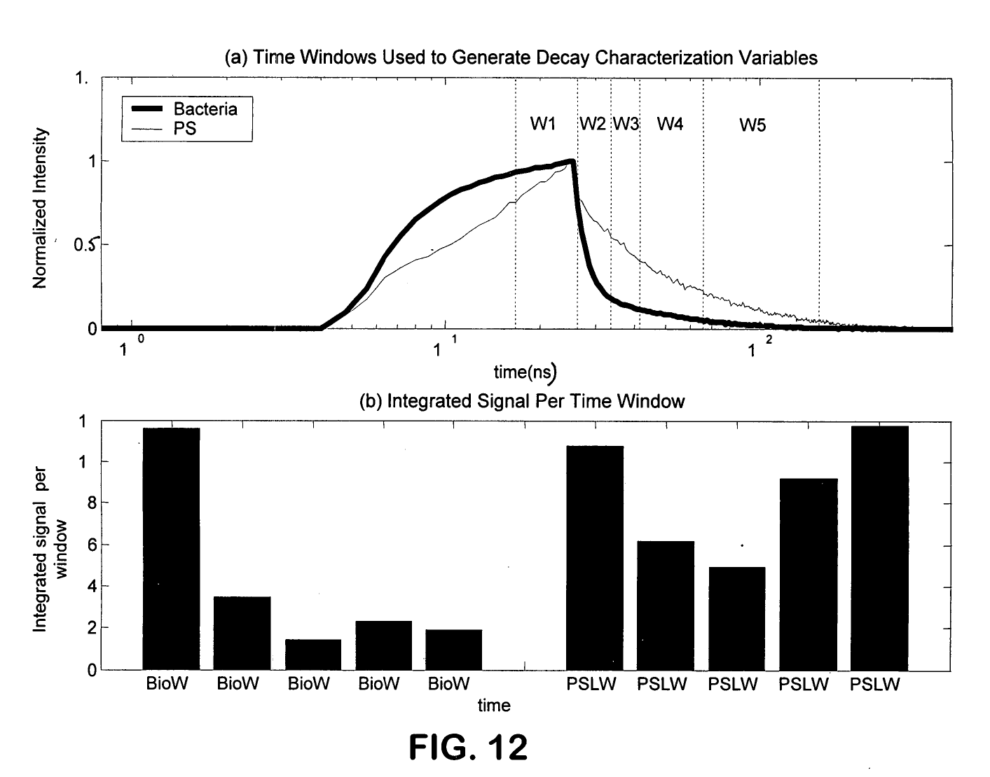

The upper graph (a) of FIG. 12 shows the time windows that can be used to integrate parts of the decay curves of FIG. 11 and the lower graph (b) of FIG. 12 shows an expected histogram of the number of photons in each window, for the bacterial and PSL decay curves. For appropriately chosen time windows, the histogram windows or values, W1 to W5, can be partially independent variables that can provide a characterization of the behavior of different emission responses (scatterers or fluorophores) from the particle.

Particle fluorescence decay characteristics are summarized by five descriptive measures (denoted as W1 to W5). Values of W1 to W5 are measured by counting the number of photons arriving within the time windows designated in FIG. 12(b). Values of W1 to W5 were generated for 60 particles, half of which were bacterial and the other half are polystyrene latex (PSL). Binary logistic regression analysis was then performed to construct a probability model that relates two of the five descriptive measures (covariates, W1 and W2) to the corresponding binary response (a bacterial or PSL particle). Various modeling techniques and diagnostic procedures have been utilized to derive the model. Key assumptions, the parameter estimation methods and underlying theory are based techniques described in, for example, Applied Logistic Regression, D. Hosmer and S. Lemeshow, John Wiley and Sons, Inc., 1989. The logistic model derived from the test data is
Y=−700.5+59.08(W1)+9.29(W2)

For any given particle, the value of (Y) is converted to the probability that the particle is bacterial by the transformation:
Probability Particle is bacterial=e^{Y}/(e^{Y}+1)

Following the logistic model generation, the instrument model was used to generate decays for 120 challenge particles. The predictor equation was used to generate probabilities for each of the model particles.

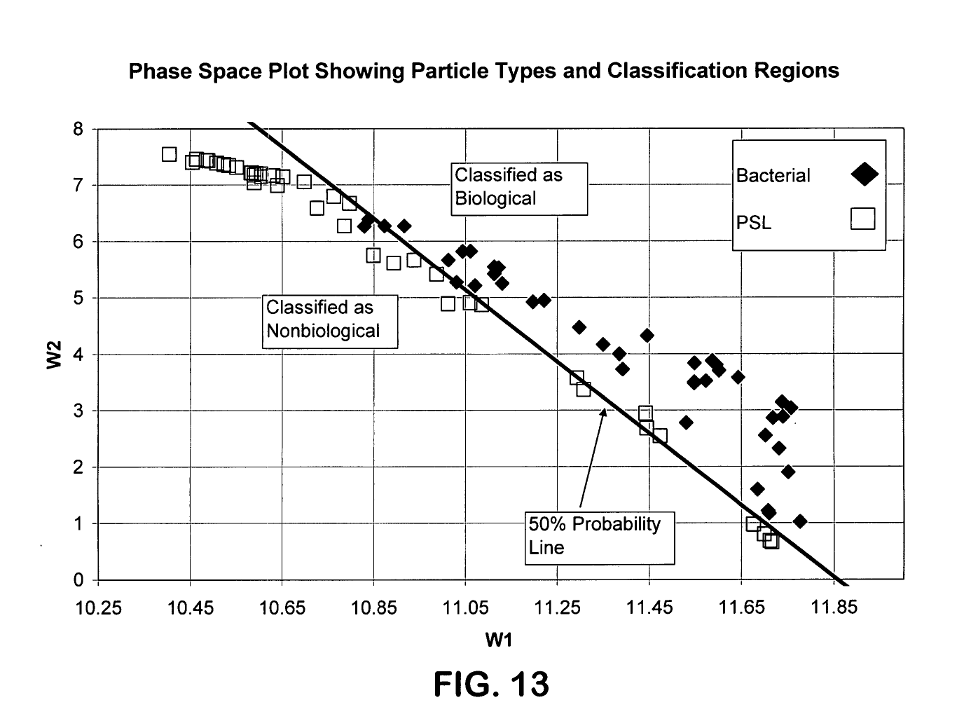

A scatter plot of W1 and W2 values with a plot of the predictor equation is shown in FIG. 13.

The challenge particle W1 and W2 values are plotted as solid diamonds (♦) if the particle was biological, and as open squares (□) if the particle was polystyrene latex. The predictor equation gives the probability of the particle being biological, with the 50% line shown on the plot. Particles falling on one side of the probability line are classified biological and those falling on the other sides as non-biological. Biological particles classified non-biological are false negatives; non-biological particles classified as biological are false positives.

Classification can be improved in three ways. First, additional gate windows may be used. FIG. 12 shows that the later gate windows may contain additional discriminating information. If adding additional windows does not improve the discrimination, the start time and width of the gate windows can be adjusted, optimized, to maximize the independence of these variables. Alternatively, the classification boundary, 50% probability as utilized above, may be shifted up or down to favor false positives or false negatives, as appropriate.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. For example, one or more detectors can be utilized in the systems and techniques of the present invention and, in accordance with some embodiments, a detector may be utilized or configured to measure a component of a composite emission decay profile; and in some cases, a second, typically separate detector can be utilized to measure a second component of the composite emission decay profile. Moreover, the time boundaries cited herein are approximate, typically based on the scientific literature, and may be adjusted and optimized for a variety or particular measurement situation. Further, the present invention has been described as characterizing an aerosol particle but need not be limited as such. Thus, one or more particles may be characterized, which can be airborne or otherwise. Accordingly, the foregoing description and drawings are by way of example only.

What is claimed is:

1. A system for classifying aerosol particles comprising:
a first detector capable of generating a first signal corresponding to a composite emission decay profile of a first emission from an aerosol particle;
a second detector capable of generating a second signal corresponding to a composite emission decay profile of a second emission from the aerosol particle; and
means for deconvolving the first and second signals into at least one discriminant vector that provides an indication of the nature of the aerosol particle.

2. A system for classifying aerosol particles comprising:
a first detector capable of generating a first signal corresponding to a first composite emission decay profile of a first emission from an aerosol particle;
a second detector capable of generating a second signal corresponding to a second composite emission decay profile of a second emission from the aerosol particle; and
a processor coupled to the first and second detectors to receive the first and second signals,
wherein the processor can determine a first scatter component and a first fluorescence component of the first composite emission decay profile and determine a second scatter component and a second fluorescence component of the second composite emission decay profile.

3. The system of claim 2, wherein the first fluorescence component comprises a first biological component and a first non-biological component and the second fluorescence component comprises a second biological component and a second non-biological component.

4. The system of claim 3, wherein the processor can determine a first scatter intensity value corresponding to the first scatter component.

5. The system of claim 4, wherein the processor can determine a first non-biological fluorescence value corresponding to the first non-biological component.

6. The system of claim 5, wherein the processor can determine a first biological fluorescence value corresponding to the first biological component.

7. The system of claim 2, further comprising a radiation source disposed to discharge electromagnetic energy to stimulate the emission from the sample.

8. The system of claim 7, wherein the radiation source comprises a first LED discharging electromagnetic energy at a first wavelength and a second LED discharging electromagnetic energy at a second wavelength.

9. A method of characterizing an aerosol particle comprising:
measuring a first composite emission decay profile of a first emission from the aerosol particle;
measuring a second composite emission decay profile of a second emission from the aerosol particle;
determining a biological fluorescence time constant of the first composite emission decay profile;
determining a biological fluorescence time constant of the second composite emission decay profile;
determining a first biological emission constant of the first composite emission decay profile; and
determining a second biological emission constant of the second composite emission decay profile.

10. The method of claim 9, further comprising stimulating the aerosol particle.

11. The method of claim 9, further comprising determining a first scatter emission constant of the first composite emission decay profile and determining a second scatter emission constant of the second composite emission decay profile.

12. The method of claim 11, further comprising determining a non-biological fluorescence time constant of the composite emission decay profile.

13. The method of claim 12, further comprising determining a non-biological emission constant of the composite emission decay profile.

14. The method of claim 13, further comprising normalizing the first scatter emission constant, the first biological emission constant, and the first non-biological emission constant relative to the first scatter emission constant to produce a first scatter component, a first biological component, and a first non-biological component.

15. The method of claim 14, further comprising mapping the first scatter component relative to the first biological component and the first non-biological component.

16. The method of claim 13, further comprising normalizing the second scatter emission constant, the second biological emission constant, and the second non-biological emission constant relative to the second scatter emission constant to produce a second scatter component, a second biological component, and a second non-biological component.

17. The method of claim 16, further comprising mapping the second scatter component relative to the second biological component and the second non-biological component.

18. The method of claim 13, further comprising determining a second biological fluorescence time constant of the first composite emission decay profile.

19. The method of claim 18, further comprising determining a second biological emission constant of the first composite emission,decay profile.

20. The method of claim 13, further comprising determining a second non-biological time constant of the first composite emission decay profile.

21. The method of claim 20, further comprising determining a second biological emission constant of the first composite emission decay profile.
